(19) United States
(12) Patent Application Publication
(10) Pub. No.: US 2024/0229962 A1
(43) Pub. Date: Jul. 11, 2024

(54) Solenoid Actuator with a Single Piece Tube

(71) Applicant: Parker-Hannifin Corporation, Cleveland, OH (US)

(72) Inventor: Yufeng Qi, Ada, MI (US)

(21) Appl. No.: 18/558,410

(22) PCT Filed: May 11, 2022
(86) PCT No.: PCT/US2022/028689

§ 371 Date: Nov. 1, 2023

Related U.S. Application Data
(60) Provisional application No. 63/226,230, filed on Jul. 28, 2021.
(60) Provisional application No. 63/243,767, filed on Sep. 14, 2021.

(51) Int. Cl. F16K 31/06

(52) U.S. Cl. CPC F16K 31/0675; F16K 31/0658

(57) ABSTRACT

An example solenoid tube (104) includes: a first cylindrical cavity portion (302), wherein the solenoid tube has a unitary construction, such that the solenoid tube is formed as a single component, wherein the solenoid tube is hollow, wherein an inner diameter of the solenoid tube varies along a length of the solenoid tube to form various cavity portions of varying diameters, and wherein the first cylindrical cavity portion has a first diameter (DI); a second cylindrical cavity portion (304) having a second diameter (D2), wherein the second diameter is greater than the first diameter; and a third cylindrical cavity portion (306) having a third diameter (D3), wherein the third diameter is smaller than the first diameter and smaller than the second diameter, such that a step (312) is formed at a transition from the second cylindrical cavity portion to the third cylindrical cavity portion.

### CROSS REFERENCE TO RELATED APPLICATION

The present application claims priority to. (i) U.S. Provisional patent application No. 63/226,230, filed on Jul. 28, 2021, and (ii) U.S. Provisional patent application No. 63/243,767, filed on Sep. 14, 2021, the entire contents of all of which are herein incorporated by reference as if fully set forth in this description.

### TECHNICAL FIELD

This disclosure relates to a solenoid tube having a single piece construction and varying inner diameters to reduce manufacturing cost and enhance solenoid force profile of a solenoid actuator comprising the solenoid tube.

### BACKGROUND

Example valves used in hydraulic or pneumatic applications can be solenoid-operated. Such valves include a solenoid actuator having a coil, a solenoid tube, and an armature coupled to a movable member (e.g., poppet, spool, or piston) of the valve. Providing an electric signal to the coil, causes the armature and the movable member to move to operate the valve in a particular state.

Current solenoid tube designs typically fall into two categories. The first solenoid tube category involves a brazed tube design. A brazed solenoid tube includes a tube with two separate sections, each having a tapered portion. The two sections are joined via a brazing process where a nonmagnetic material is used to join the two sections at the tapered portions. Making such a brazed solenoid tube thus includes machining the tube with an external groove, then brazing the external groove, then machining again to remove extraneous material. Further, the solenoid force profile generated by the solenoid actuator is dependent on the taper angle of the tubes. A slight change in such angle may affect the force profile substantially, and thus tight angular tolerance may be required. Controlling such tight angle tolerance through the machining and brazing processes is difficult and costly.

The second solenoid tube category involves welding several tubes or components. Each tube is machined separately and then they are welded together. One of the tubes can be made of a nonmagnetic material, while the others are made of a magnetic material. Making such a solenoid tube involving several machining and welding processes can be costly, and may require tight concentricity tolerances between the different components.

Thus, existing solenoid tube configurations are sensitive to manufacturing processes and manufacturing tolerances to control the solenoid force profile, and are costly. It may thus be desirable to have a solenoid tube made from a single piece involving a single machining process (e.g., turning on a lathe). It may also be desirable to have several features in the solenoid tube that are not costly to adjust and that facilitate controlling the magnetic flux lines to achieve a desired solenoid force profile. It is with respect to these and other considerations that the disclosure made herein is presented.

### SUMMARY

The present disclosure describes implementations that relate to a solenoid actuator with a single piece tube.

In a first example implementation, the present disclosure describes a solenoid tube. The solenoid tube includes: a first cylindrical cavity portion, wherein the solenoid tube has a unitary construction, such that the solenoid tube is formed as a single component, wherein the solenoid tube is hollow, wherein an inner diameter of the solenoid tube varies along a length of the solenoid tube to form various cavity portions of varying diameters, and wherein the first cylindrical cavity portion has a first diameter; a second cylindrical cavity portion having a second diameter, wherein the second diameter is greater than the first diameter; and a third cylindrical cavity portion having a third diameter, wherein the third diameter is smaller than the first diameter and smaller than the second diameter, such that: (i) a step is formed at a transition from the second cylindrical cavity portion to the third cylindrical cavity portion, (ii) a thickness of the solenoid tube at the first cylindrical cavity portion is smaller than a thickness of the solenoid tube at the third cylindrical cavity portion.

In a second example implementation, the present disclosure describes a solenoid actuator including a solenoid tube having a unitary construction, such that the solenoid tube is formed as a single component, wherein the solenoid tube is hollow, wherein an inner diameter of the solenoid tube varies along a length of the solenoid tube to form various cavity portions comprising: a first cylindrical cavity portion having a first diameter, a second cylindrical cavity portion having a second diameter, wherein the second diameter is greater than the first diameter, and a third cavity portion, wherein (i) a step is formed at a transition from the second cylindrical cavity portion to the third cavity portion, and (ii) a thickness of the solenoid tube at the first cylindrical cavity portion is smaller than a thickness of the solenoid tube at the third cavity portion. The solenoid actuator also includes an armature disposed, at least partially, and slidably accommodated within the solenoid tube, wherein the armature comprises: a first cylindrical portion having a first outer diameter, and a second portion, wherein a respective step is formed at a transition from the first cylindrical portion to the second portion, wherein the respective step of the armature corresponds to the step of the solenoid tube such that the solenoid tube accommodates the armature when the armature moves within the solenoid tube.

In a third example implementation, the present disclosure describes a valve. The valve includes the solenoid actuator of the second example implementation. The valve also includes a seal mounted to the armature; and a valve seat member comprising a first port, a second port, and a seat. The solenoid actuator is configured to operate in: (i) an unactuated state in which the solenoid coil is de-energized and the seal is seated at the seat of the valve seat member to block fluid flow between the first port and the second port, and (ii) an actuated state in which the solenoid coil is energized and a solenoid force is applied to the armature, thereby causing the armature to move within the solenoid tube, lifting the seal off the seat and allowing fluid flow between the first port and the second port.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 illustrates a cross-sectional view of a valve in a closed state, in accordance with an example implementation.

FIG. 2 illustrates a cross-sectional view of the valve of FIG. 1 in an open state, in accordance with an example implementation.

FIG. 3 illustrates a partial cross-sectional view of a solenoid tube, in accordance with an example implementation.

FIG. 4 illustrates a partial cross-sectional view of an armature, in accordance with an example implementation.

FIG. 5 illustrates a partial view of a solenoid tube and an armature with magnetic flux line paths therebetween, in accordance with an example implementation.

FIG. 6 illustrates a graph of simulation results showing solenoid force generated versus stroke of an armature at different current levels supplied to a solenoid coil, in accordance with an example implementation.

FIG. 7 illustrates a partial schematic view of a solenoid tube and an armature depicting an outer diameter of a cylindrical portion of the armature, in accordance with an example implementation.

FIG. 8 is a graph showing effect of changing the outer diameter depicted in FIG. 7 on a solenoid force profile, in accordance with an example implementation.

FIG. 9 illustrates a partial schematic view of a solenoid tube and an armature depicting parameters affecting solenoid force profile of the valve of FIG. 1, in accordance with an example implementation.

FIG. 10 is a graph showing effect of changing a gap on a solenoid force profile of a proportional valve, in accordance with an example implementation.

FIG. 11 illustrates is a graph showing effect of changing a gap on a solenoid force profile of an on/off valve, in accordance with an example implementation.

FIG. 12 illustrates a partial cross-sectional view of a solenoid tube, in accordance with an example implementation.

FIG. 13 illustrates a partial cross-sectional view of an armature, in accordance with an example implementation.

### DETAILED DESCRIPTION

Disclosed herein are valves and assemblies including a solenoid actuator having a solenoid tube with a single piece construction. The solenoid tube is hollow and has an inner diameter that varies along a length of the solenoid tube to form several cylindrical cavity portions with varying inner diameters, and at least one internal step. An armature of the solenoid actuator is disposed, at least partially, within the solenoid tube and has an external step that corresponds to the internal step of the solenoid tube. Such configuration enables the solenoid actuator to have at least three paths for magnetic flux generated when a coil of the solenoid actuator is energized. The three paths affect a solenoid force generated when the coil is energized, i.e., the pushing or pulling force applied to the armature. Changing dimensions of the features of the solenoid tube changes a profile of the solenoid force as desired, and changing such dimensions might not involve costly manufacturing processes.

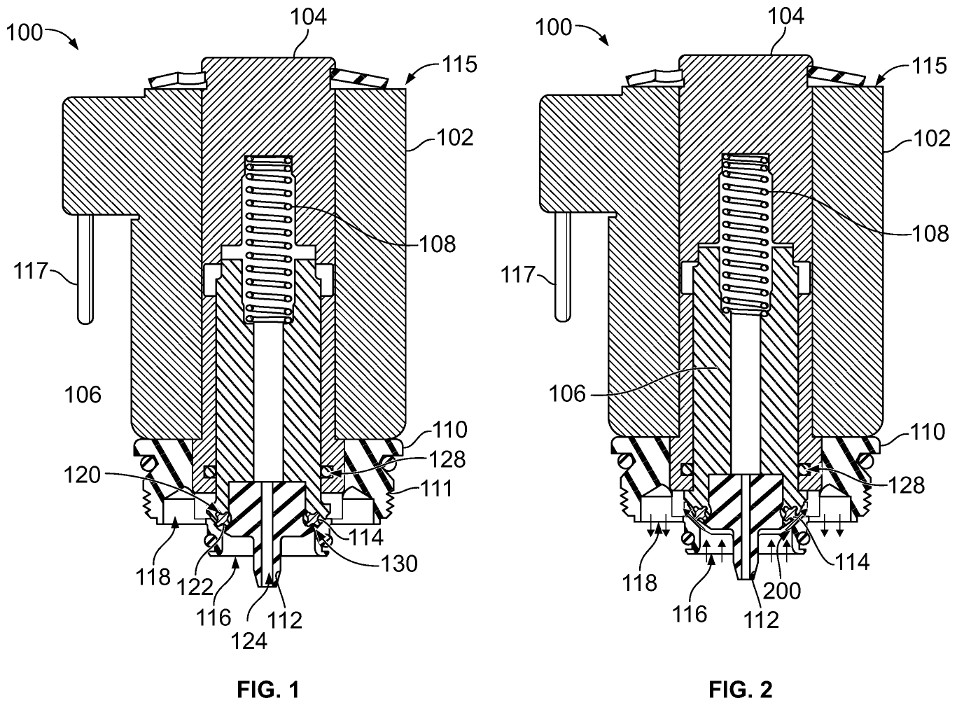

FIG. 1 illustrates a cross-sectional view of a valve 100 in a closed state, in accordance with an example implementation. The closed state can also be referred to as the unactuated state.

The valve 100 includes a solenoid coil 102, a solenoid tube 104, a plunger or an armature 106, a spring 108, a valve seat member 110, and a nose piece 112. The valve seat member 110 has threads 111. The threads 111 facilitate mounting the valve 100 in a cavity of a manifold or fluid line having corresponding threads, for example. The solenoid coil 102, the solenoid tube 104, and the armature 106 can be referred to collectively as a solenoid actuator 115.

In an example, the nose piece 112 can be press-fit into the armature 106. In another example, the nose piece 112 can be threadedly engaged with the armature 106. As such, the nose piece 112 and the armature 106 move as a single component.

The armature 106 and the nose piece 112 together form a cavity in which a seal 114 is disposed. In an example, the seal 114 can be configured as an over-molded seal. In this example, the nose piece 112 can be press-fitted into the armature 106. Particularly, the armature 106 can have a recess 120, and the nose piece 112 can have a protrusion 122, such that the recess 120 and the protrusion 122 form the seal cavity in which the seal 114 is disposed.

The valve seat member 110 includes a first port 116 and a second port 118. The first port 116 is formed as an inner opening at a nose end of the valve seat member 110, and the second port 118 is formed as an outer opening in the valve seat member 110 and straddles or circumscribes the first port 116.

The valve 100 is configured to control fluid flow between the first port 116 and the second port 118. The valve 100 can be configured as a bi-directional valve that allows fluid flow from the first port 116 to the second port 118 and vice versa based on the state of the solenoid actuator 115 and based on which port has the higher pressure fluid. The term “fluid” is used herein generally to indicate air, gas, liquid, hydraulic fluid, water, fuel, etc.

The nose piece 112 has a channel 124 and the armature 106 has a respective channel 126. With this configuration, fluid at the first port 116 is communicated through the channels 124, 126 to a seal 128 between the exterior surface the armature 106 and an interior surface of the solenoid tube 104. As such, the armature 106 can be pressure-balanced as fluid applying a fluid force on a first end of the armature 106 (e.g., the end disposed at the first port 116) is also applying a respective fluid force on a second end of the armature 106 (the end at the seal 128). This way the force generated by fluid pressure is eliminated and pressure variations does not affect the solenoid actuator force.

The spring 108 has a first end (e.g., upper end) resting against an interior surface of the solenoid tube 104, and has a second end (e.g., lower end) resting against a shoulder 109 formed within the armature 106. With this configuration, the spring 108 applies a biasing force on the armature 106 toward a seat 130 formed by a tapered interior surface of the valve seat member 110.

The valve 100 is shown in FIG. 1 in an unactuated state, i.e., no electric current is provided to the solenoid coil 102. In this position, the spring 108 biases the armature 106 downward in FIG. 1 toward the seat 130, such that the seal 114 rests against, or is seated at, the seat 130. This way, the seal 114 blocks fluid flow between the first port 116 and the second port 118.

The solenoid coil 102 can be disposed in a case and is configured to generate a magnetic field when an electric current is provided through windings of the solenoid coil 102. For example, the valve 100 can include electric connectors such as electric connector 117, and an electronic controller of the valve 100 can be configured to provide an electric current signal to the solenoid coil 102 via the electric connectors.

When an electrical current is provided through the windings of the solenoid coil 102, a magnetic field is generated. Magnetic flux of the magnetic field is directed through the solenoid tube 104, the armature 106, then the solenoid tube 104 again and back to the solenoid coil 102 in a loop. As a result, the armature 106, which is movable, is attracted upward in FIG. 1. In other words, when an electrical current is applied to the solenoid coil 102, the generated magnetic field applies a solenoid force to attract the armature 106 upward.

As such, the solenoid force is a pulling force that tends to pull the armature 106 upward in FIG. 1. Although a pull-type solenoid actuator is described herein, the configuration of the solenoid tube 104 and the armature 106 disclosed herein can be applied to a push-type solenoid actuator.

The solenoid force is proportional to a magnitude of the electrical command or signal (e.g., magnitude of electrical current or voltage applied to the solenoid coil 102). As the armature 106 and the nose piece 112 are lifted off (e.g., move upward in FIG. 1), the seal 114 is unseated off the seat 130.

FIG. 2 illustrates a cross-sectional view of the valve 100 in an open state, in accordance with an example implementation. The open state can also be referred to as the actuated state.

The armature 106 moves and compresses the spring 108, thereby causing the spring force applied by the spring 108 on the armature 106 to increase. The armature 106 can thus move until a force equilibrium is achieved between the spring force and the solenoid force applied to the armature 106. As the armature 106, the nose piece 112, and the seal 114 lift off, a flow area 200 is formed to allow fluid flow between the first port 116 and the second port 118. For example, if fluid is received at the first port 116, it flows through the flow area 200 to the second port 118. Conversely, if fluid is received at the second port 118, it flows through the flow area 200 to the first port 116.

The valve 100 can be configured as an on/off valve or as a proportional valve. An on/off valve opens all the way when solenoid coil 102 is energized or actuated and closes when the solenoid coil 102 is de-energized. A proportional valve involves the armature 106 moving to a particular longitudinal position that is proportional to the electric signal to the solenoid coil 102. The lager the magnitude of the electric signal (i.e., the larger the electric current or voltage), the larger the stroke of the armature 106. This way, the fluid flow rate between the first port 116 and the second port 118 is proportional to the electric signal.

The configuration of the solenoid tube 104 and the armature 106 controls the magnetic flux passing therethrough and determines whether the valve 100 is an on/off or proportional valve. Further, the configuration of the solenoid tube 104 and the armature 106 controls the profile of the solenoid force (e.g., how the solenoid force changes with a magnitude of the electric current provided to the solenoid coil 102).

The solenoid tube 104 disclosed herein has a single piece construction, i.e., has a unitary construction (e.g., made as a single component as opposed to more than one component joined together). Further, the solenoid tube 104 has several features formed on its interior surface, and the armature 106 has corresponding features that allow the magnetic flux generated by the solenoid coil 102 to flow through at least three different paths. The solenoid force is the resultant of all three paths. Also, the parameters (e.g., dimensions of several features) of the solenoid tube 104 and the armature 106 that can be changed to change the force profile can be adjusted using inexpensive manufacturing processes such as lathe turning.

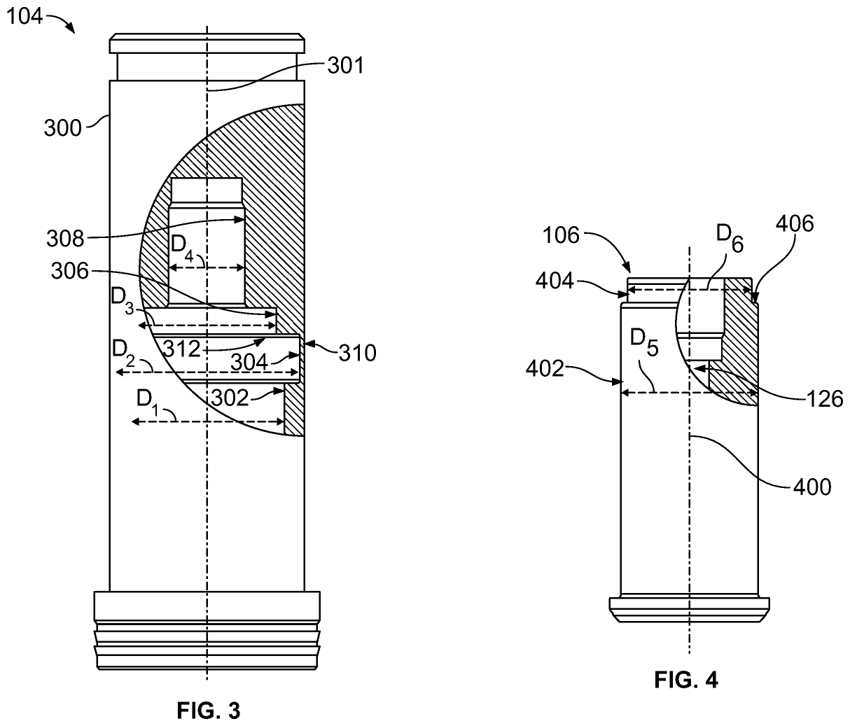

FIG. 3 illustrates a partial cross-sectional view of the solenoid tube 104, in accordance with an example implementation. As shown in FIG. 3, the solenoid tube 104 comprises a solenoid tube body 300. The solenoid tube body 300 can be generally-cylindrical but can also take other shapes. The solenoid tube body 300 has a hollow portion that receives the armature 106 and the spring 108 therein.

An inner diameter of the solenoid tube body 300 varies along a length of the solenoid tube body 300 (i.e., along a longitudinal axis 301 of the solenoid tube 104) to form various cavity portions of varying diameters. In other words, the solenoid tube body 300 of the solenoid tube 104 has several interior cylindrical cavity portions having different diameters. A diameter of a cavity is an inner diameter of the solenoid tube body 300 at the cavity.

Particularly, the solenoid tube 104 has (i) a first cylindrical cavity portion 302 having a first diameter D₁, (ii) a second cylindrical cavity portion 304 having a second diameter D₂, (iii) a third cylindrical cavity portion 306 having a third diameter D₃, and (iv) a fourth cylindrical cavity portion 308 having a fourth diameter D₄. The fourth diameter D₄ of the fourth cylindrical cavity portion 308 corresponds to the outer diameter of the spring 108 so as to accommodate the spring 108 therein.

The second cylindrical cavity portion 304 is longitudinally-interposed between the first cylindrical cavity portion 302 and the third cylindrical cavity portion 306. Further, the first diameter D₁ and the third diameter D₃ are larger than the second diameter D₂. As such, the second cylindrical cavity portion 304 is formed as an undercut between the first cylindrical cavity portion 302 and the third cylindrical cavity portion 306. With this configuration, a longitudinal portion of the solenoid tube 104 at the undercut (i.e., at the second cylindrical cavity portion 304) is a thin-walled portion 310 where the second diameter D₂ is the largest inner diameter and the wall of the solenoid tube 104 is thinnest (i.e., has the smallest thickness). As an example for illustration, D₂ can be about 15.3 millimeter (mm), D₄ can be about 11.3 mm, and the thinnest wall thickness at the second cylindrical cavity portion 304 can be about 0.34 mm.

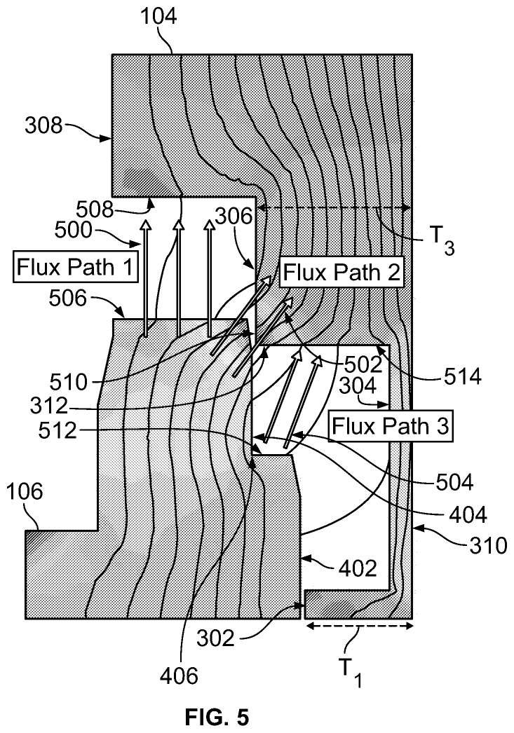

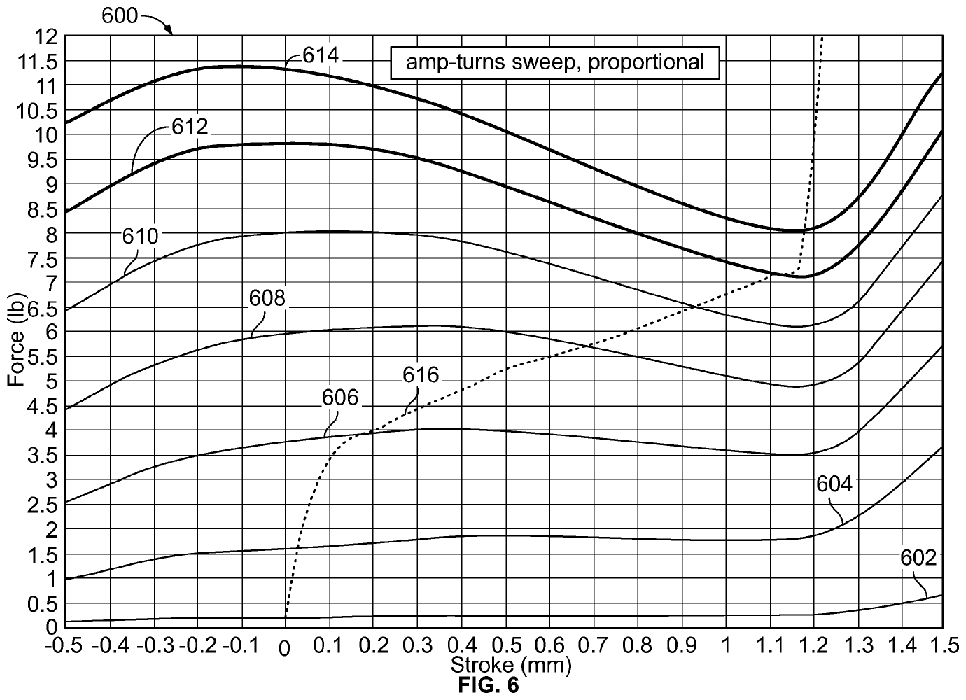

Further, the first diameter D₁ of the first cylindrical cavity portion 302 is larger than the third diameter D₃ of the third cylindrical cavity portion 306. As such, a thickness of the wall of the solenoid tube 104 at the first cylindrical cavity portion 302 (see thickness T₁ in FIG. 5) is smaller than a respective thickness of the third cylindrical cavity portion 306 (see thickness T₃ in FIG. 5).

Further, the interior surface of the solenoid tube 104 at the transition from the second diameter D₂ of the second cylindrical cavity portion 304 to the third diameter D₃ of the third cylindrical cavity portion 306 forms a step 312. As described below, the armature 106 has a step formed by its exterior surface that corresponds to the step 312 and causes an additional flux path to be formed compared to conventional solenoid actuator configurations.

FIG. 4 illustrates a partial cross-sectional view of the armature 106, in accordance with an example implementation. As shown in FIG. 4, the armature 106 is generally-cylindrical and has the channel 126 formed therein.

An outer diameter of the armature 106 varies along its length (i.e., along a longitudinal axis 400 of the armature 106), such that the armature 106 includes at least two cylindrical portions having different outer diameters. Particularly, the armature 106 has (i) a first cylindrical portion 402 having a first outer diameter D₅, and (ii) a second cylindrical portion 404 having a second outer diameter D₆. As an example for illustration, D₆ can be about 12.4 mm.

As depicted in FIGS. 1-2, the armature 106 is disposed, at least partially, within the solenoid tube 104. Also, as described above the armature 106 is movable within the solenoid tube 104. As such, the armature 106 is slidably-accommodated within the solenoid tube 104. The term “slidably accommodated” is used herein to indicate that the armature 106 is positioned relative to the solenoid tube 104 with sufficient clearance therebetween, enabling movement of the armature 106 relative to the solenoid tube 104. As such, the diameter D₅ is smaller than the diameter D₁ and the diameter D₆ is smaller than the diameter D₃ such that there is a clearance between the armature 106 and the solenoid tube 104 that allows the armature 106 to move longitudinally.

The first outer diameter D₅ of the first cylindrical portion 402 is larger than the second outer diameter D₆. As such, a step 406 is formed at the transition from the first outer diameter D₅ of the first cylindrical portion 402 to the second outer diameter D₆ of the second cylindrical portion 404. The step 406 formed by the exterior surface of the armature 106 corresponds to the step 312 formed by the interior surface of the solenoid tube 104. This configuration of the solenoid tube 104 and the armature 106 causes at least three magnetic flux paths to be formed therebetween.

FIG. 5 illustrates a partial view of the solenoid tube 104 and the armature 106 with magnetic flux line paths therebetween, in accordance with an example implementation. FIG. 5 depicts the armature 106 in an unactuated position.

As depicted FIG. 5, a portion of the magnetic flux “leaks” through the thin-walled portion 310 of the solenoid tube 104. However, the configuration of the solenoid tube 104 and the armature 106 compensates for such leakage.

Particularly, the above-described configurations of the solenoid tube 104 and the armature 106 enables magnetic flux of the magnetic field generated by the solenoid coil 102 to take three different paths. The magnetic flux generated by the solenoid coil 102 first traverses the solenoid tube 104 in a lateral direction (e.g., to the left in FIG. 5). A portion of such flux loops through the thin-walled portion 310 and then back to the solenoid coil 102 to close the loop. Another portion, the majority of the magnetic flux, traverses a clearance between the armature 106 and the solenoid tube 104, then travels through the armature 106, then takes one of three paths back to the solenoid tube 104: a first path 500, a second path 502, and a third path 504.

The first path 500 is traversed through a flat end portion 506 of the armature 106 to flat internal portion 508 of the solenoid tube 104 facing the flat end portion 506. The second path 502 is traversed through a gap 510 proximate a first corner of the armature 106 formed between the flat end portion 506 and the second cylindrical portion 404 and a second corner of the solenoid tube 104 formed at the transition forming the step 312. The third path 504 is traversed through a flat portion 512 of the armature 106 formed due to the step 406 to a flat portion 514 of the solenoid tube 104 facing the flat portion 512.

The third path 504 is enabled due to the steps 312, 406, and the third path 504 may increase the magnitude of the solenoid force. Particularly, the solenoid force results from an additive effect of all three flux paths. Conventional solenoid tube and armature configurations may enable two flux paths, but not the third path described above.

Further, referring to FIGS. 3 and 5 together, due to the configuration that the first diameter D₁ being greater than the third diameter D₃, a thickness T₁ of the first cylindrical cavity portion 302 is smaller than a thickness T₃ of the third cylindrical cavity portion 306. This configuration may enhance the solenoid force by reducing wasted energy. Particularly, magnetic flux may be restricted or choked through the gap 510; however, a the large thickness T₃ of the third cylindrical cavity portion 306 has an opposing effect as it limits choking the magnetic flux and reduces wasted magnetic energy.

On the other hand, the smaller thickness T₁ of the first cylindrical cavity portion 302 represents a smaller distance through which the magnetic flux travels as it traverses the solenoid tube 104 before “jumping” to the armature 106. Thus, the different thicknesses of the solenoid tube 104 may reduce wasted energy and limit choking the magnetic flux to a small region, thereby enabling achieving a larger solenoid force for a given size of the solenoid tube 104 and the armature 106.

FIG. 6 illustrates a graph 600 of simulation results showing solenoid force generated versus stroke of the armature 106 at different current levels supplied to the solenoid coil 102, in accordance with an example implementation. In the graph 600, the force is shown in pound-force (lb) on the y-axis, whereas the stroke of the armature 106 is shown on the x-axis in mm.

Lines 602, 604, 606, 608, 610, 612, and 614 show the solenoid force produced versus the stroke of the armature 106 at different electric current levels provided to the solenoid coil 102. Particularly, line 602 shows the solenoid force produced versus the stroke of the armature 106 at an electric current of 100 milliamps (mA), line 604 shows the solenoid force at an electric current of 250 mA, line 606 shows the solenoid force at an electric current of 400 mA, line 608 shows the solenoid force at an electric current of 500 mA, line 610 shows the solenoid force at an electric current of 700 mA, line 612 shows the solenoid force at an electric current of 850 mA, and line 614 shows the solenoid force at an electric current of 1000 mA.

Line 616 shows spring force of the spring 108 versus the stroke of the armature 106. For a given electric current level, the armature 106 achieves equilibrium position when the line 616 intersects with one of the lines 602-614 that corresponds to the given electric current level.

As shown, the force level increases with the current level. The shape and level of force is the resultant of all three magnetic flux paths described above. Simulation results have shown that the force levels are greater than those achieved by a corresponding brazed tube configuration.

The shape of the force curves shown in FIG. 6 are consistent with performance of a proportional valve where the position of the armature 106 is proportional to the electric current level. Advantageously, with the configuration of the solenoid tube 104 and the armature 106 described above, the performance (i.e., the shape and magnitude of the solenoid force for a given current level) can be tuned with simple, inexpensive manufacturing operations that do not require tight tolerances.

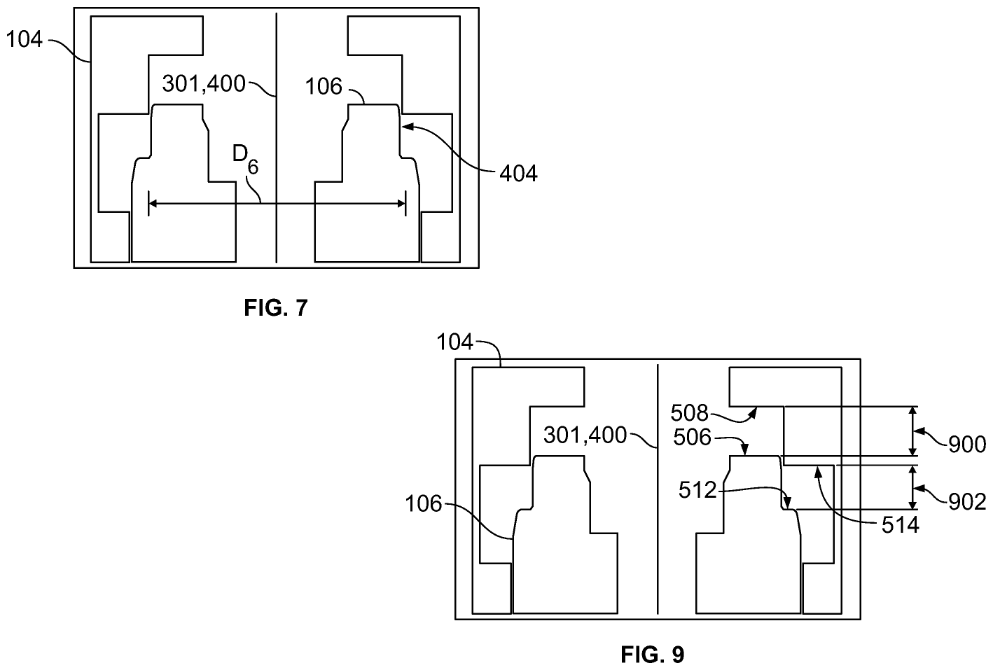

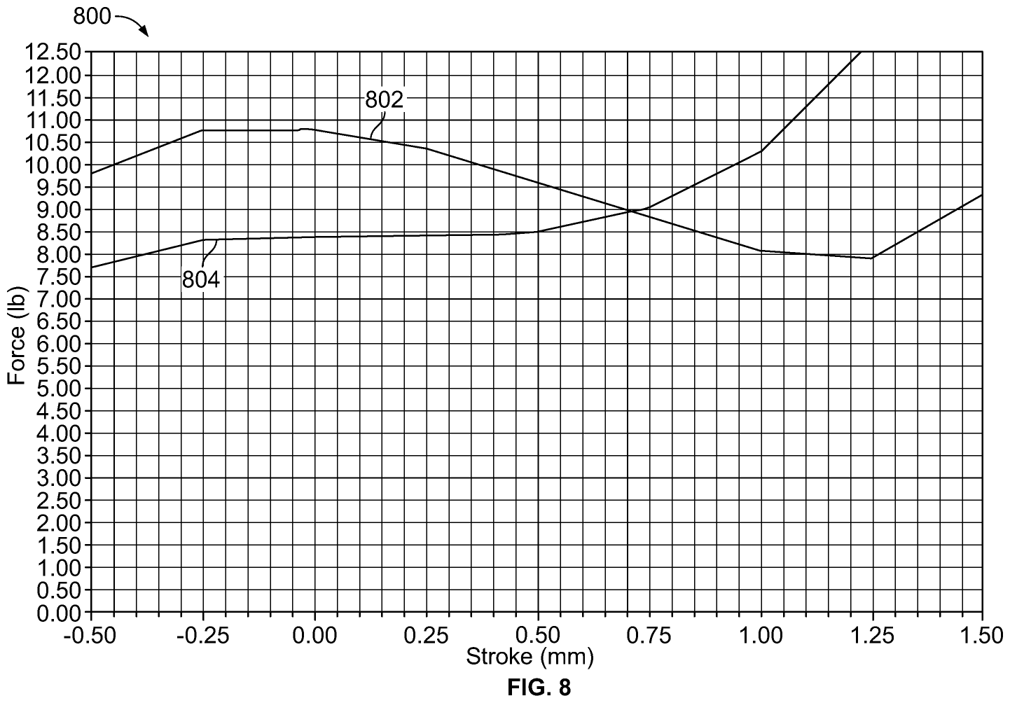

FIG. 7 illustrates a partial schematic view of the solenoid tube 104 and the armature 106 depicting the second outer diameter D₆ of the second cylindrical portion 404 of the armature 106, and FIG. 8 is a graph 800 showing effect of changing the second outer diameter D₆ on the solenoid force profile, in accordance with an example implementation. Changing the second outer diameter D₆ involves a lathe turning manufacturing operation that can control the second outer diameter D₆ accurately without being costly.

FIG. 8 depicts a line 802 showing variation of the solenoid force in (lb) versus stroke of the armature 106 in (mm) when the second outer diameter D₆ is 10.8 mm. The line 802 is consistent with the solenoid force profile of a proportional valve. Line 804 on the other hand shows variation of the solenoid force in (lb) versus stroke of the armature 106 in (mm) when the second outer diameter D₆ is 8.8 mm. The line 804 is consistent with the solenoid force profile of an on/off valve.

Varying the second outer diameter D₆ to any value between 8.8 mm and 10.8 mm can cause the solenoid force to have any desired profile between the lines 802, 804. As mentioned above, turning the armature 106 on a lathe to change the second outer diameter D₆ is not costly and can be controlled to a high degree of accuracy compared to conventional valves involving tapered pieces where an angle of taper is to be controlled to tight tolerances to achieve a desired profile. Changing other dimensional parameters of the solenoid tube 104 and the armature 106 can also be accomplished using inexpensive manufacturing operations and can achieve different solenoid force profiles as desired.

FIG. 9 illustrates a partial schematic view of the solenoid tube 104 and the armature 106 depicting parameters affecting solenoid force profile of the valve 100, in accordance with an example implementation. FIG. 9 depicts the armature 106 in an unactuated position. In such unactuated position, a gap 900 separates the flat end portion 506 of the armature 106 from the flat internal portion 508 of the solenoid tube 104. The size of the gap 900 can be used to tune proportional performance of the valve 100.

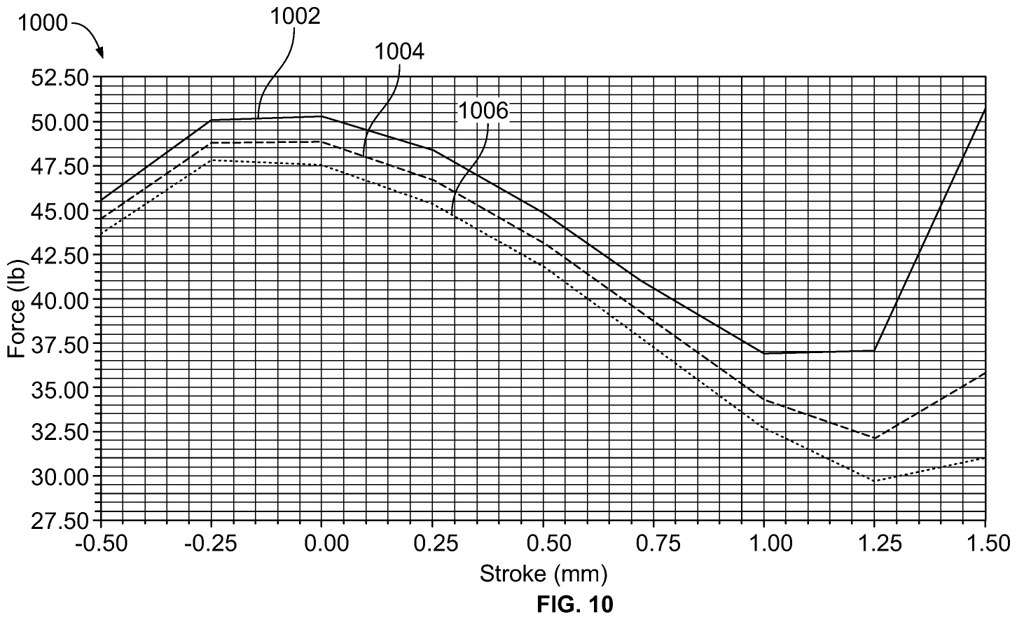

FIG. 10 is a graph 1000 showing effect of changing the gap 900 on the solenoid force profile of a proportional valve, in accordance with an example implementation. FIG. 10 depicts lines 1002, 1004, 1006 showing variation of the solenoid force in (lb) versus the stroke of the armature 106 in (mm) at different sizes for the gap 900. Particularly, the line 1002 shows the variation when the gap 900 is 1.7 mm, the line 1004 shows the variation when the gap 900 is 2.0 mm, and the line 1006 shows the variation when the gap 900 is 2.3 mm.

All three lines 1002, 1004, 1006 are consistent with a solenoid force profile suitable for a proportional valve (e.g., when the second outer diameter D₆ shown in FIG. 7 is 10.8 mm). However, each line shows a different force level. The smaller the gap 900, the higher the force levels that can be achieved. Thus, the gap 900 can be tuned to achieve a desired solenoid force profile. Tuning the gap 900 can be accomplished using inexpensive manufacturing operations and can be used to achieve different solenoid force profiles as desired.

Referring back to FIG. 9, a gap 902 separates the flat portion 512 of the armature 106 and the flat portion 514 of the solenoid tube 104. The size of the gap 902 can be used to tune on/off performance of the valve 100.

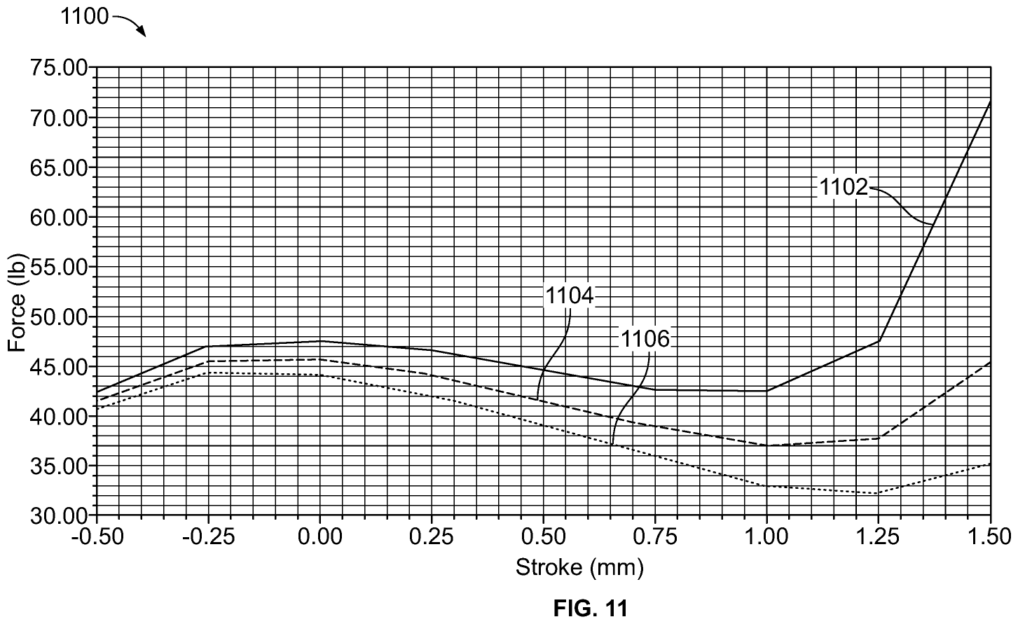

FIG. 11 is a graph 1100 showing effect of changing the gap 902 on the solenoid force profile of an on/off valve, in accordance with an example implementation. FIG. 11 depicts lines 1102, 1104, 1106 showing variation of the solenoid force in (lb) versus stroke of the armature 106 in (mm) at different sizes for the gap 902. Particularly, the line 1102 shows the variation when the gap 902 is 1.55 mm, the line 1104 shows the variation when the gap 902 is 1.8 mm, and the line 1106 shows the variation when the gap 902 is 2.05 mm.

All three lines 1102, 1104, 1106 are consistent with a solenoid force profile suitable for an on/off valve (e.g., when the second outer diameter D₆ shown in FIG. 7 is 8.8 mm). However, each line shows a different force level. Thus, the gap 902 can be tuned to achieve a desired solenoid force profile. Tuning the gap 902 can be accomplished using inexpensive manufacturing operations and can be used to achieve different solenoid force profiles as desired.

Other dimensional parameters can be changed to affect performance and the solenoid force profile of the valve 100. For example, one or more of the interior surfaces of the solenoid tube 104 and corresponding exterior surfaces of the armature 106 can be tapered at a particular angle. Such angle can be tuned to achieve a desired solenoid force profile, in applications where a longer stroke is desired.

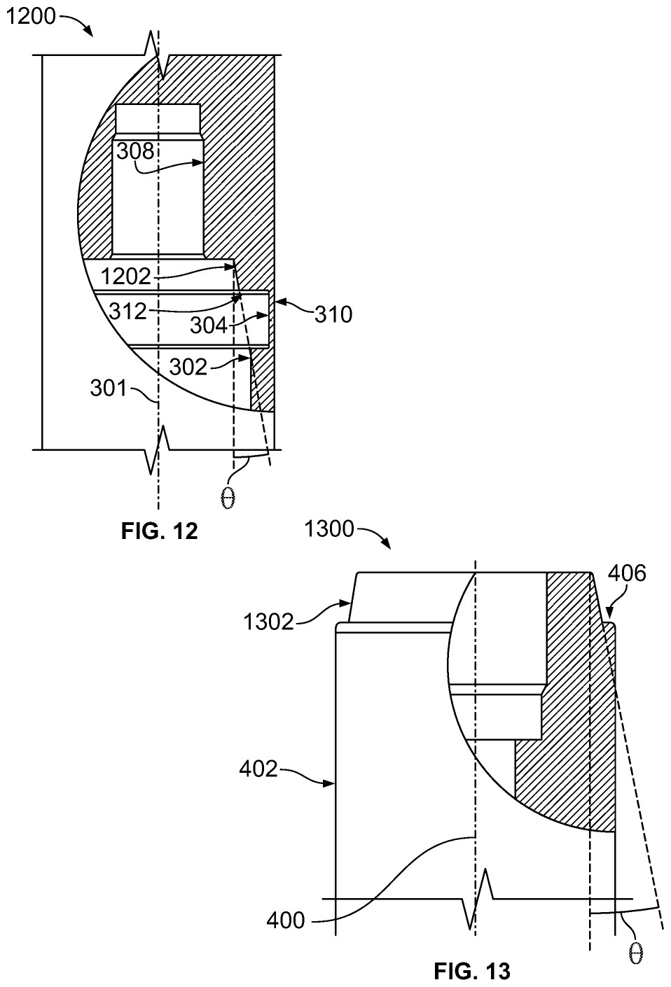

FIG. 12 illustrates a partial cross-sectional view of a solenoid tube 1200, and FIG. 13 illustrates a partial cross-sectional view of an armature 1300, in accordance with an example implementation. The solenoid tube 1200 differs from the solenoid tube 104 in that, rather than having the third cylindrical cavity portion 306, the solenoid tube 1200 has a third cavity portion configured as a conical or tapered cavity portion 1202 (i.e., an interior surface of the solenoid tube 1200 is tapered at the tapered cavity portion 1202). The surface bounding the tapered cavity portion 1202 forms an angle θ with the longitudinal axis 301 of the solenoid tube 1200. Tuning the angle θ may change the solenoid force profile of the valve 100. As an example for illustration, the angle θ can be about 6 degrees.

Similarly, the armature 1300 differs from the armature 106 in that, rather than having the second cylindrical portion 404, the armature 1300 has a conical or tapered portion 1302 corresponding to the tapered cavity portion 1202 of the solenoid tube 104. Particularly, the exterior surface of the tapered portion 1302 forms an angle θ with the longitudinal axis 400 of the armature 1300. Tuning the angle θ may change the solenoid force profile of the valve 100.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is a solenoid tube comprising: a first cylindrical cavity portion, wherein the solenoid tube has a unitary construction, such that the solenoid tube is formed as a single component, wherein the solenoid tube is hollow, wherein an inner diameter of the solenoid tube varies along a length of the solenoid tube to form various cavity portions of varying diameters, and wherein the first cylindrical cavity portion has a first diameter; a second cylindrical cavity portion having a second diameter, wherein the second diameter is greater than the first diameter; and a third cylindrical cavity portion having a third diameter, wherein the third diameter is smaller than the first diameter and smaller than the second diameter, such that: (i) a step is formed at a transition from the second cylindrical cavity portion to the third cylindrical cavity portion, (ii) a thickness of the solenoid tube at the first cylindrical cavity portion is smaller than a thickness of the solenoid tube at the third cylindrical cavity portion.

EEE 2 is the solenoid tube of EEE 1, wherein the solenoid tube comprises a thin-walled portion bounding the second cylindrical cavity portion having largest inner diameter and smallest thickness.

EEE 3 is the solenoid tube of any of EEEs 1-2, wherein the second cylindrical cavity portion is longitudinally-interposed between the first cylindrical cavity portion and the third cylindrical cavity portion, such that the second cylindrical cavity portion is formed as an undercut between the first cylindrical cavity portion and the third cylindrical cavity portion.

EEE 4 is the solenoid tube of any of EEEs 1-3, further comprising: a fourth cylindrical cavity portion having a fourth diameter that is smaller than respective diameters of the first cylindrical cavity portion, the second cylindrical cavity portion, and the third cylindrical cavity portion.

EEE 5 is a solenoid actuator comprising: a solenoid tube having a unitary construction, such that the solenoid tube is formed as a single component, wherein the solenoid tube is hollow, wherein an inner diameter of the solenoid tube varies along a length of the solenoid tube to form various cavity portions comprising: a first cylindrical cavity portion having a first diameter, a second cylindrical cavity portion having a second diameter, wherein the second diameter is greater than the first diameter, and a third cavity portion, wherein (i) a step is formed at a transition from the second cylindrical cavity portion to the third cavity portion, and (ii) a thickness of the solenoid tube at the first cylindrical cavity portion is smaller than a thickness of the solenoid tube at the third cavity portion; and an armature disposed, at least partially, and slidably accommodated within the solenoid tube, wherein the armature comprises: a first cylindrical portion having a first outer diameter, and a second portion, wherein a respective step is formed at a transition from the first cylindrical portion to the second portion, wherein the respective step of the armature corresponds to the step of the solenoid tube such that the solenoid tube accommodates the armature when the armature moves within the solenoid tube.

EEE 6 is the solenoid actuator of EEE 5, wherein the third cavity portion is a third cylindrical cavity portion having a third diameter, wherein the third diameter is smaller than the first diameter and smaller than the second diameter.

EEE 7 is the solenoid actuator of any of EEEs 5-6, wherein the second portion of the armature is a second cylindrical portion having a second outer diameter that is smaller than the first outer diameter to form the respective step of the armature.

EEE 8 is the solenoid actuator of any of EEEs 5-7, wherein the third cavity portion is a tapered at a particular angle, and wherein the second portion of the armature is tapered at the particular angle.

EEE 9 is the solenoid actuator of any of EEEs 5-8, wherein the solenoid tube comprises a thin-walled portion bounding the second cylindrical cavity portion having largest inner diameter and smallest thickness.

EEE 10 is the solenoid actuator of any of EEEs 5-9, wherein the second cylindrical cavity portion is longitudinally-interposed between the first cylindrical cavity portion and the third cavity portion, such that the second cylindrical cavity portion is formed as an undercut between the first cylindrical cavity portion and the third cavity portion.

EEE 11 is the solenoid actuator of any of EEEs 5-10, wherein the solenoid tube further comprises: a fourth cylindrical cavity portion having a fourth diameter that is smaller than respective diameters of the first cylindrical cavity portion and the second cylindrical cavity portion, and wherein the solenoid actuator further comprises: a spring disposed, at least partially, within the fourth cylindrical cavity portion and applying a biasing force on the armature.

EEE 12 is the solenoid actuator of any of EEEs 5-11, further comprising: a solenoid coil disposed about the solenoid tube, wherein when the solenoid coil is energized, a magnetic field is generated, and wherein magnetic flux of the magnetic field traverses at least three different paths comprising: (i) a first path from a flat end portion of the armature to a flat internal portion of the solenoid tube facing the flat end portion, (ii) a gap proximate a first corner of the armature formed between the flat end portion and the second portion of the armature and a second corner of the solenoid tube formed at the transition forming the step, and (iii) a third path from a flat portion of the armature formed due to the respective step formed therein to a flat portion of the solenoid tube facing the flat portion of the armature and formed at the transition from the second cylindrical cavity portion to the third cavity portion.

EEE 13 is a valve comprising: a solenoid actuator comprising: (i) a solenoid tube having a unitary construction, such that the solenoid tube is formed as a single component, wherein the solenoid tube is hollow, wherein an inner diameter of the solenoid tube varies along a length of the solenoid tube to form various cavity portions comprising: a first cylindrical cavity portion having a first diameter, a second cylindrical cavity portion having a second diameter, wherein the second diameter is greater than the first diameter, and a third cavity portion, wherein a step is formed at a transition from the second cylindrical cavity portion to the third cavity portion, (ii) an armature disposed, at least partially, and slidably accommodated within the solenoid tube, wherein the armature comprises: a first cylindrical portion having a first outer diameter and a second portion, wherein a respective step is formed at a transition from the first cylindrical portion to the second portion, wherein the respective step of the armature corresponds to the step of the solenoid tube such that the solenoid tube accommodates the armature when the armature moves within the solenoid tube, and (iii) a solenoid coil; a seal mounted to the armature; and a valve seat member comprising a first port, a second port, and a seat, wherein the solenoid actuator is configured to operate in: (i) an unactuated state in which the solenoid coil is de-energized and the seal is seated at the seat of the valve seat member to block fluid flow between the first port and the second port, and (ii) an actuated state in which the solenoid coil is energized and a solenoid force is applied to the armature, thereby causing the armature to move within the solenoid tube, lifting the seal off the seat and allowing fluid flow between the first port and the second port.

EEE 14 is the valve of EEE 13, wherein the third cavity portion is a third cylindrical cavity portion having a third diameter, wherein the third diameter is smaller than the first diameter and smaller than the second diameter, such that a thickness of the solenoid tube at the third cavity portion is greater than respective thicknesses of the solenoid tube at the first cylindrical cavity portion and the second cylindrical cavity portion.

EEE 15 is the valve of any of EEEs 13-14, wherein the second portion of the armature is a second cylindrical portion having a second outer diameter that is smaller than the first outer diameter to form the respective step of the armature.

EEE 16 is the valve of any of EEEs 13-15, wherein the third cavity portion is a tapered at a particular angle, and wherein the second portion of the armature is tapered at the particular angle.

EEE 17 is the valve of any of EEEs 13-16, wherein the solenoid tube comprises a thin-walled portion bounding the second cylindrical cavity portion having largest inner diameter and smallest thickness.

EEE 18 is the valve of any of EEEs 13-17, wherein the second cylindrical cavity portion is longitudinally-interposed between the first cylindrical cavity portion and the third cavity portion, such that the second cylindrical cavity portion is formed as an undercut between the first cylindrical cavity portion and the third cavity portion.

EEE 19 is the valve of any of EEEs 13-18, wherein the solenoid tube further comprises: a fourth cylindrical cavity portion having a fourth diameter that is smaller than respective diameters of the first cylindrical cavity portion and the second cylindrical cavity portion, and wherein the solenoid actuator further comprises: a spring disposed, at least partially, within the fourth cylindrical cavity portion and applying a biasing force on the armature against the solenoid force.

EEE 20 is the valve of any of EEEs 13-19, wherein when the solenoid coil is energized, a magnetic field is generated, and wherein magnetic flux of the magnetic field traverses at least three different paths comprising: (i) a first path from a flat end portion of the armature to a flat internal portion of the solenoid tube facing the flat end portion, (ii) a gap proximate a first corner of the armature formed between the flat end portion and the second portion of the armature and a second corner of the solenoid tube formed at the transition forming the step, and (iii) a third path from a flat portion of the armature formed due to the respective step formed therein to a flat portion of the solenoid tube facing the flat portion of the armature and formed at the transition from the second cylindrical cavity portion to the third cavity portion.

What is claimed is:

1. A solenoid tube comprising:
a first cylindrical cavity portion, wherein the solenoid tube has a unitary construction, such that the solenoid tube is formed as a single component, wherein the solenoid tube is hollow, wherein an inner diameter of the solenoid tube varies along a length of the solenoid tube to form various cavity portions of varying diameters, and wherein the first cylindrical cavity portion has a first diameter;
a second cylindrical cavity portion having a second diameter, wherein the second diameter is greater than the first diameter; and
a third cylindrical cavity portion having a third diameter, wherein the third diameter is smaller than the first diameter and smaller than the second diameter, such that: (i) a step is formed at a transition from the second cylindrical cavity portion to the third cylindrical cavity portion, (ii) a thickness of the solenoid tube at the first cylindrical cavity portion is smaller than a thickness of the solenoid tube at the third cylindrical cavity portion.

2. The solenoid tube of claim 1, wherein the solenoid tube comprises a thin-walled portion bounding the second cylindrical cavity portion having largest inner diameter and smallest thickness.

3. The solenoid tube of claim 1, wherein the second cylindrical cavity portion is longitudinally-interposed between the first cylindrical cavity portion and the third cylindrical cavity portion, such that the second cylindrical cavity portion is formed as an undercut between the first cylindrical cavity portion and the third cylindrical cavity portion.

4. The solenoid tube of claim 1, further comprising:
a fourth cylindrical cavity portion having a fourth diameter that is smaller than respective diameters of the first cylindrical cavity portion, the second cylindrical cavity portion, and the third cylindrical cavity portion.

5. A solenoid actuator comprising:
a solenoid tube having a unitary construction, such that the solenoid tube is formed as a single component, wherein the solenoid tube is hollow, wherein an inner diameter of the solenoid tube varies along a length of the solenoid tube to form various cavity portions comprising:
a first cylindrical cavity portion having a first diameter,
a second cylindrical cavity portion having a second diameter, wherein the second diameter is greater than the first diameter, and
a third cavity portion, wherein (i) a step is formed at a transition from the second cylindrical cavity portion to the third cavity portion, and (ii) a thickness of the solenoid tube at the first cylindrical cavity portion is smaller than a thickness of the solenoid tube at the third cavity portion; and
an armature disposed, at least partially, and slidably accommodated within the solenoid tube, wherein the armature comprises:
a first cylindrical portion having a first outer diameter, and
a second portion, wherein a respective step is formed at a transition from the first cylindrical portion to the second portion, wherein the respective step of the armature corresponds to the step of the solenoid tube such that the solenoid tube accommodates the armature when the armature moves within the solenoid tube.

6. The solenoid actuator of claim 5, wherein the third cavity portion is a third cylindrical cavity portion having a third diameter, wherein the third diameter is smaller than the first diameter and smaller than the second diameter.

7. The solenoid actuator of claim 5, wherein the second portion of the armature is a second cylindrical portion having a second outer diameter that is smaller than the first outer diameter to form the respective step of the armature.

8. The solenoid actuator of claim 5, wherein the third cavity portion is a tapered at a particular angle, and wherein the second portion of the armature is tapered at the particular angle.

9. The solenoid actuator of claim 5, wherein the solenoid tube comprises a thin-walled portion bounding the second cylindrical cavity portion having largest inner diameter and smallest thickness.

10. The solenoid actuator of claim 5, wherein the second cylindrical cavity portion is longitudinally-interposed between the first cylindrical cavity portion and the third cavity portion, such that the second cylindrical cavity portion is formed as an undercut between the first cylindrical cavity portion and the third cavity portion.

11. The solenoid actuator of claim 5, wherein the solenoid tube further comprises:
a fourth cylindrical cavity portion having a fourth diameter that is smaller than respective diameters of the first cylindrical cavity portion and the second cylindrical cavity portion, and wherein the solenoid actuator further comprises:
a spring disposed, at least partially, within the fourth cylindrical cavity portion and applying a biasing force on the armature.

12. The solenoid actuator of claim 5, further comprising:
a solenoid coil disposed about the solenoid tube, wherein when the solenoid coil is energized, a magnetic field is generated, and wherein magnetic flux of the magnetic field traverses at least three different paths comprising: (i) a first path from a flat end portion of the armature to a flat internal portion of the solenoid tube facing the flat end portion, (ii) a gap proximate a first corner of the armature formed between the flat end portion and the second portion of the armature and a second corner of the solenoid tube formed at the transition forming the step, and (iii) a third path from a flat portion of the armature formed due to the respective step formed therein to a flat portion of the solenoid tube facing the flat portion of the armature and formed at the transition from the second cylindrical cavity portion to the third cavity portion.

13. A valve comprising:
a solenoid actuator comprising: (i) a solenoid tube having a unitary construction, such that the solenoid tube is formed as a single component, wherein the solenoid tube is hollow, wherein an inner diameter of the solenoid tube varies along a length of the solenoid tube to form various cavity portions comprising: a first cylindrical cavity portion having a first diameter, a second cylindrical cavity portion having a second diameter, wherein the second diameter is greater than the first diameter, and a third cavity portion, wherein a step is formed at a transition from the second cylindrical cavity portion to the third cavity portion, (ii) an armature disposed, at least partially, and slidably accommodated within the solenoid tube, wherein the armature comprises: a first cylindrical portion having a first outer diameter and a second portion, wherein a respective step is formed at a transition from the first cylindrical portion to the second portion, wherein the respective step of the armature corresponds to the step of the solenoid tube such that the solenoid tube accommodates the armature when the armature moves within the solenoid tube, and (iii) a solenoid coil;
a seal mounted to the armature; and
a valve seat member comprising a first port, a second port, and a seat, wherein the solenoid actuator is configured to operate in: (i) an unactuated state in which the solenoid coil is de-energized and the seal is seated at the seat of the valve seat member to block fluid flow between the first port and the second port, and (ii) an actuated state in which the solenoid coil is energized and a solenoid force is applied to the armature, thereby causing the armature to move within the solenoid tube, lifting the seal off the seat and allowing fluid flow between the first port and the second port.

14. The valve of claim 13, wherein the third cavity portion is a third cylindrical cavity portion having a third diameter, wherein the third diameter is smaller than the first diameter and smaller than the second diameter, such that a thickness of the solenoid tube at the third cavity portion is greater than respective thicknesses of the solenoid tube at the first cylindrical cavity portion and the second cylindrical cavity portion.

15. The valve of claim 13, wherein the second portion of the armature is a second cylindrical portion having a second outer diameter that is smaller than the first outer diameter to form the respective step of the armature.

16. The valve of claim 13, wherein the third cavity portion is a tapered at a particular angle, and wherein the second portion of the armature is tapered at the particular angle.

17. The valve of claim 13, wherein the solenoid tube comprises a thin-walled portion bounding the second cylindrical cavity portion having largest inner diameter and smallest thickness.

18. The valve of claim 13, wherein the second cylindrical cavity portion is longitudinally-interposed between the first cylindrical cavity portion and the third cavity portion, such that the second cylindrical cavity portion is formed as an undercut between the first cylindrical cavity portion and the third cavity portion.

19. The valve of claim 13, wherein the solenoid tube further comprises:
a fourth cylindrical cavity portion having a fourth diameter that is smaller than respective diameters of the first cylindrical cavity portion and the second cylindrical cavity portion, and wherein the solenoid actuator further comprises:
a spring disposed, at least partially, within the fourth cylindrical cavity portion and applying a biasing force on the armature against the solenoid force.

20. The valve of claim 13, wherein when the solenoid coil is energized, a magnetic field is generated, and wherein magnetic flux of the magnetic field traverses at least three different paths comprising: (i) a first path from a flat end portion of the armature to a flat internal portion of the solenoid tube facing the flat end portion, (ii) a gap proximate a first corner of the armature formed between the flat end portion and the second portion of the armature and a second corner of the solenoid tube formed at the transition forming the step, and (iii) a third path from a flat portion of the armature formed due to the respective step formed therein to a flat portion of the solenoid tube facing the flat portion of the armature and formed at the transition from the second cylindrical cavity portion to the third cavity portion.
